(19) United States
(12) Patent Application Publication
(10) Pub. No.: US 2019/0373852 A1
(43) Pub. Date: Dec. 12, 2019

(54) FEEDER DEVICE FOR ATTRACTING GAME

(71) Applicant: Douglas Figgins, Hockley, TX (US)

(72) Inventor: Douglas Figgins, Hockley, TX (US)

(21) Appl. No.: 16/433,360

(22) Filed: Jun. 6, 2019

Related U.S. Application Data
(60) Provisional application No. 62/682,890, filed on Jun. 9, 2018.

(51) Int. Cl. A01K 5/02; A01K 7/04; A01K 5/01; A01K 7/00; A01K 7/02; A01M 31/00

(52) U.S. Cl. CPC A01K 5/0258; A01K 7/04; A01M 31/008; A01K 7/005; A01K 7/025; A01K 5/0135

(57) ABSTRACT

Discloses is a feeder device for attracting game comprising a cuboid-shaped box comprising four vertical walls joined at the edges of a base member. Further, the feeder device includes a vertical partition wall within the cuboid-shaped box separating a feed bin unit and a reservoir unit. Further, the feeder device includes a first upper hatch for the feed bin unit and a second upper hatch for the reservoir unit. Further, the feeder device includes a motor housing comprising a motor to power an auger installed within the feed bin unit. Further, the feeder device includes a feeder attached to an outer wall of the feed bin unit, wherein the feeder receives the feed pellets from the feed bin unit through the auger. Further, the feeder device includes a trough attached to an outer wall of the reservoir unit, wherein the trough receives water from the reservoir unit.

### RELATED APPLICATION(S)

Under provisions of 35 U.S.C. § 119e, the Applicant(s) claim the benefit of U.S. provisional application No. 62/682,890, filed on 9 Jun. 2018, which is incorporated herein by reference.

### FIELD OF THE INVENTION

Generally, the present disclosure relates generally to hunting equipment and accessories, and in particular to a hunter's feeder device for attracting game.

### BACKGROUND

For many property owners, attracting deer and similar game animals to their property is desirable. These include weekend hunters who reserve large tracts of land in a natural state as personal game preserves, as well as homeowners with nothing more than a large back yard, who find it enjoyable to watch these animals.

Therefore, there is a need for improved device which can provide feed and water for the animals, such that the animals are gently convinced to stay on the property or close by and that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Discloses is a feeder device for attracting game comprising a cuboid-shaped box comprising four vertical walls joined at the edges of a base member. Further, the feeder device includes a plurality of anchor legs supporting the base member. Further, the feeder device includes a vertical partition wall within the cuboid-shaped box separating a feed bin unit and a reservoir unit. wherein the feed bin unit is configured to store feed pellets and the reservoir unit is configured to store water. Further, the feeder device includes a first upper hatch for the feed bin unit. Further, the feeder device includes a second upper hatch for the reservoir unit. Further, the feeder device includes a motor housing comprising a motor to power an auger installed within the feed bin unit, wherein the motor housing is attached to an outer wall of the feed bin unit. Further, the feeder device includes a feeder attached to an outer wall of the feed bin unit, wherein the feeder receives the feed pellets from the feed bin unit through the auger. Further, the feeder device includes a trough attached to an outer wall of the reservoir unit, wherein the trough receives water from the reservoir unit.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a top view of a feeder device for attracting game in accordance with an exemplary embodiment.

FIG. 2 is a front view of the feeder device for attracting game.

FIG. 3 is a right side view of the feeder device for attracting game.

FIG. 4 is a rear view of the feeder device for attracting game.

FIG. 5 is a rear top perspective view of the feeder device for attracting game.

FIG. 6 is a front top perspective view of the feeder device for attracting game.

FIG. 7 is a top perspective partial close-up view of hatches of the feeder device for attracting game.

FIG. 8 is a top perspective partial close-up view of the hatches in open configuration.

FIG. 9 is a front perspective partial close-up view of a trough of the feeder device for attracting game.

FIG. 10 is a rear perspective partial close-up view of a feeder of the feeder device for attracting game.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a feeder device, embodiments of the present disclosure are not limited to use only in this context.

According to some embodiments, a hunter's feeder device for attracting game is disclosed. The device provides an internal feed bin and an internal water reservoir, both with large storage capacities and hinged, latched upper hatches for refilling purposes. The feed bin dispenses feed pellets with a battery-powered auger. The reservoir dispenses drinking water through a float valve system. The device may be used to attract deer and similar game animals for hunting or other purposes. The hunter's feeder device is an inexpensive device which can provide feed and water for these animals, such that the animals are gently convinced to stay on the property or close by.

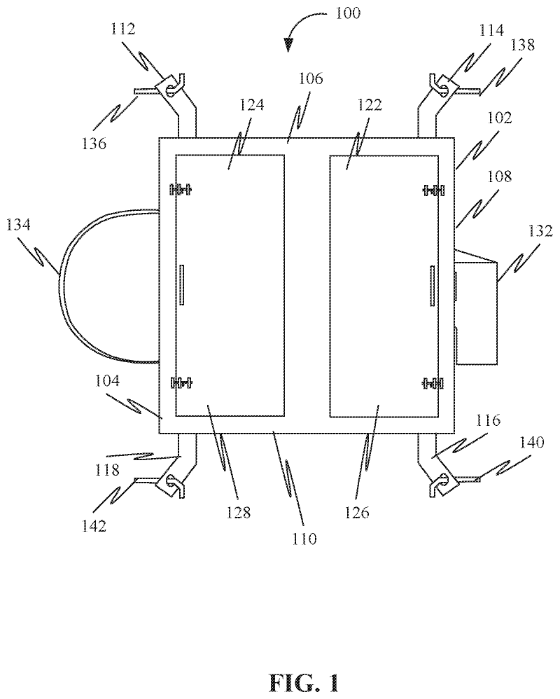

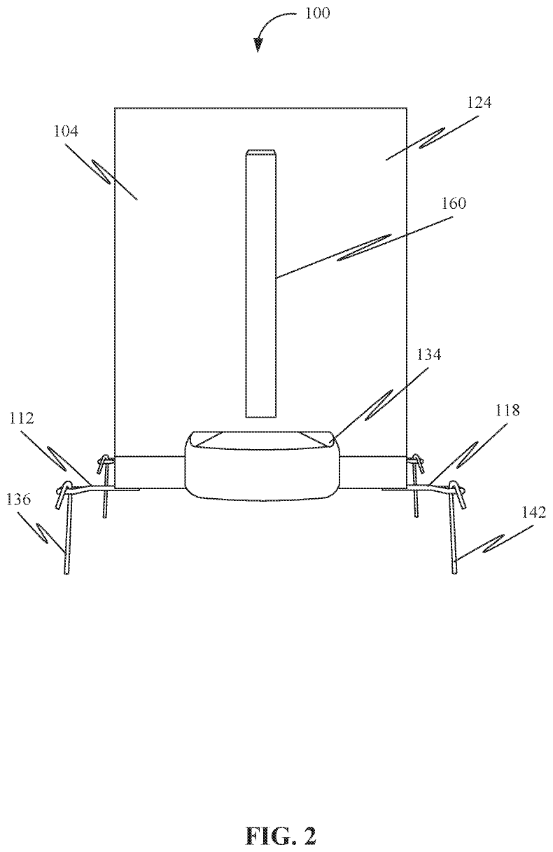

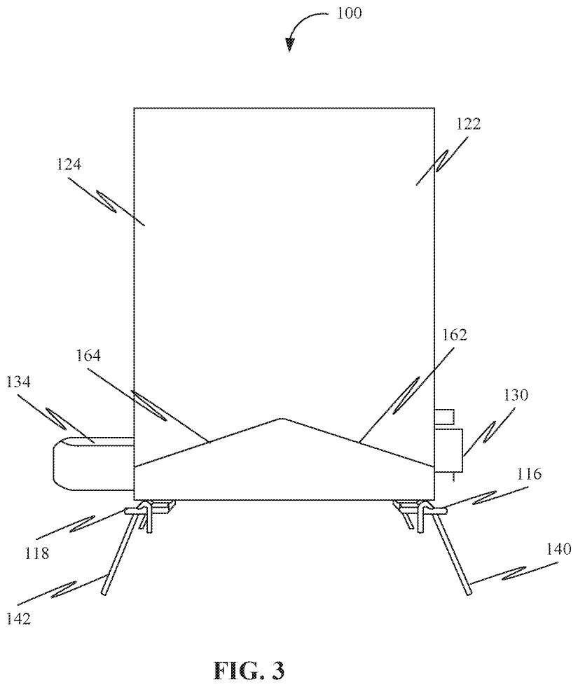

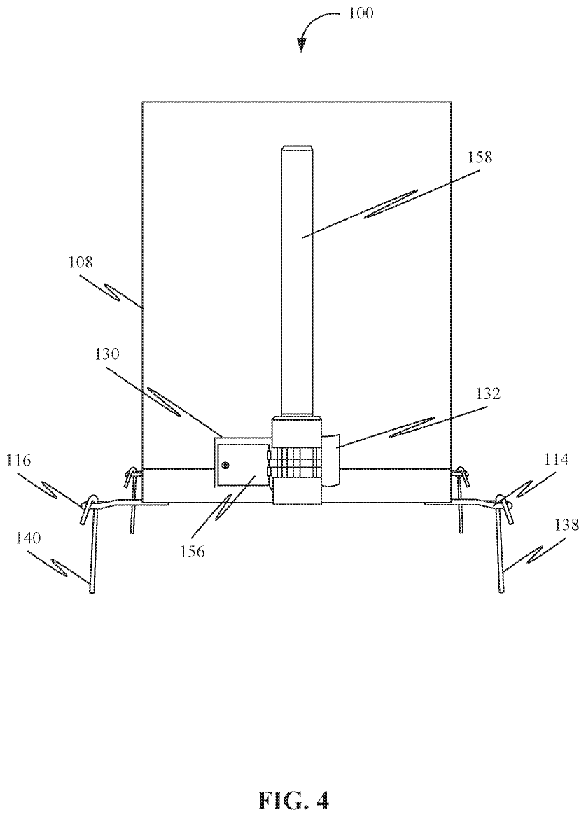

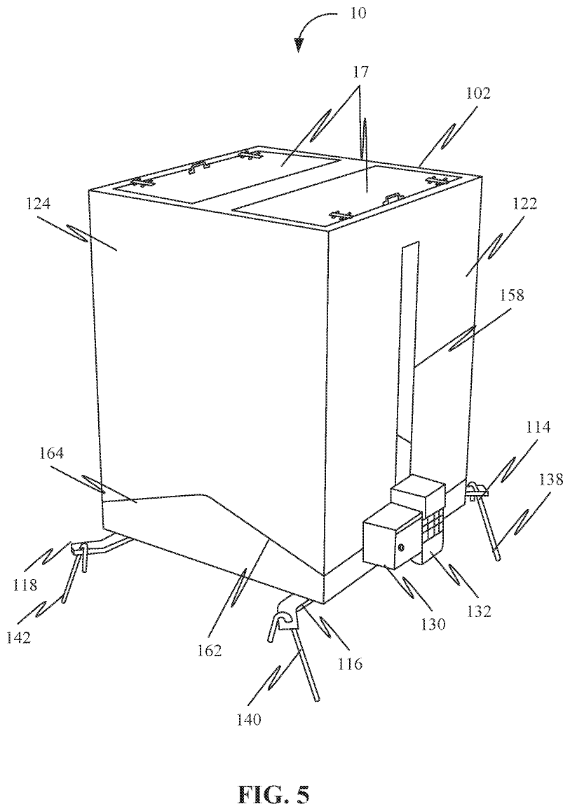

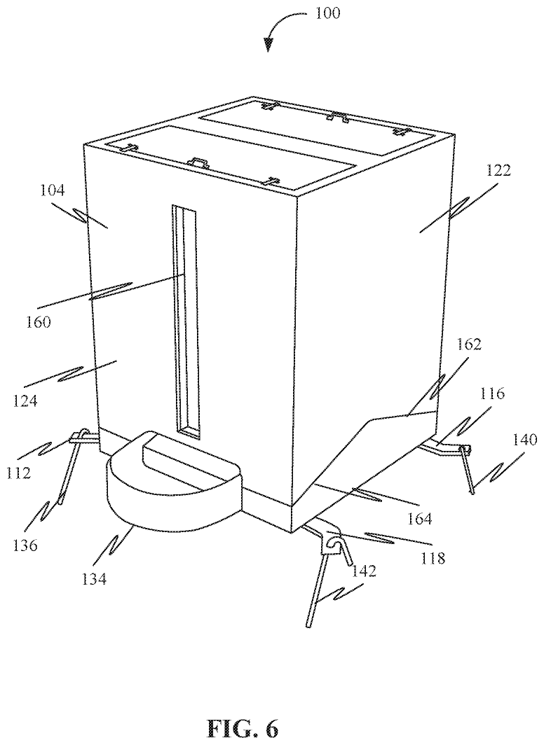

Referring now to figures, FIG. 1 is a top view of a feeder device 100 for attracting game. FIG. 2 is a front view of the feeder device 100 for attracting game. FIG. 3 is a right side view of the feeder device 100 for attracting game. FIG. 4 is a rear view of the feeder device 100 for attracting game. FIG. 5 is a rear top perspective view of the feeder device 100 for attracting game. FIG. 6 is a front top perspective view of the feeder device 100 for attracting game.

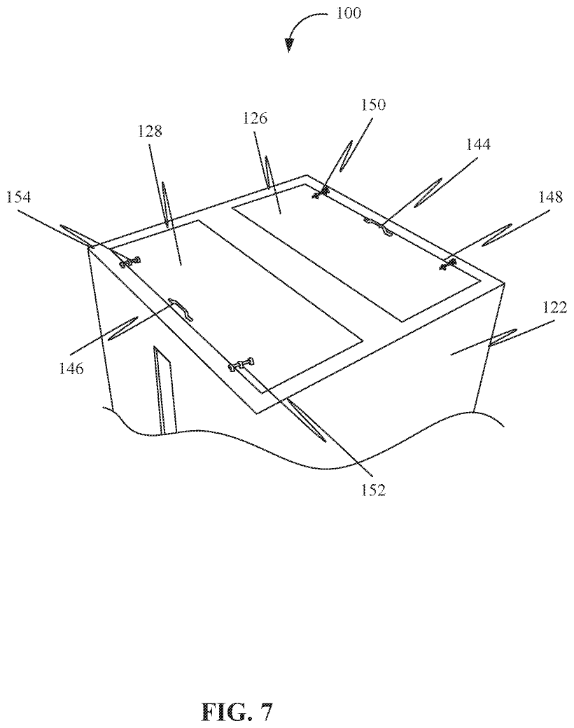

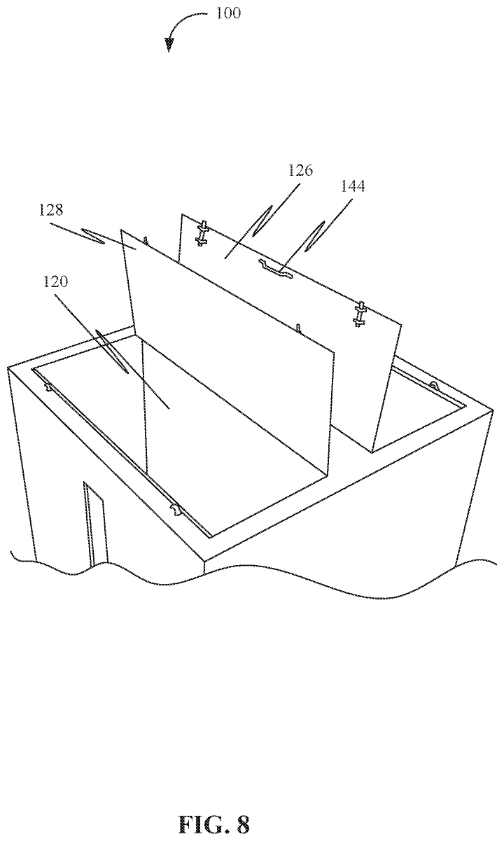

FIG. 7 is a top perspective partial close-up view of hatches 126-128 (for e.g. first upper hatch 126 and second upper hatch 128) of the feeder device 100 for attracting game. FIG. 8 is a top perspective partial close-up view of the hatches 126-128 in open configuration.

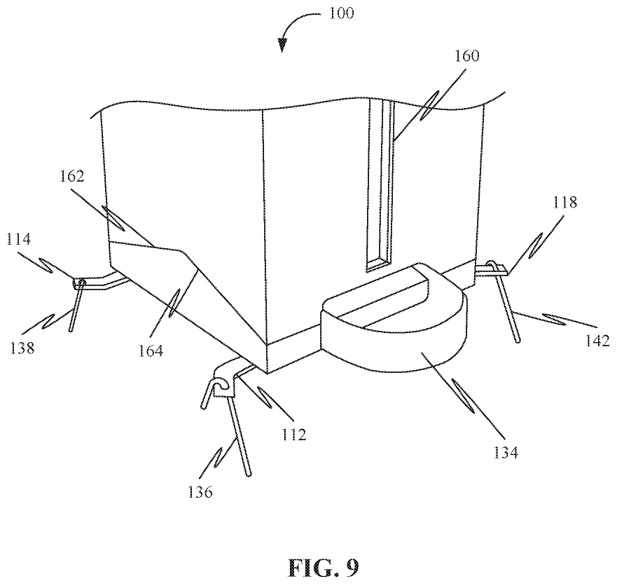

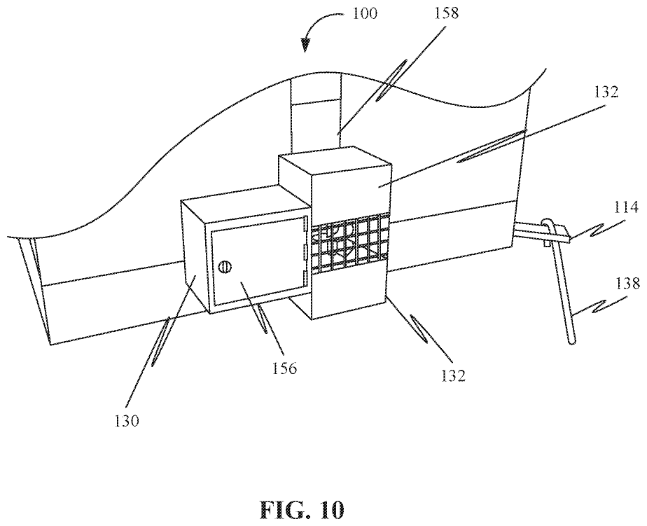

FIG. 9 is a front perspective partial close-up view of a trough 134 of the feeder device for attracting game. FIG. 10 is a rear perspective partial close-up view of a feeder 132 of the feeder device for attracting game.

The feeder device 100 for attracting game comprises a cuboid-shaped box 102 comprising four vertical walls 104-110 (including vertical wall 104, vertical wall 106, vertical wall 108, and vertical wall 110) joined at the edges of a base member (not shown). Further, one edge of each of the four vertical walls 104-110 are joined with an edge of the base member. Further, the feeder device 100 comprises a plurality of anchor legs 112-118 (including anchor leg 112, anchor leg 114, anchor leg 116, and anchor leg 118) supporting the base member.

Further, the feeder device 100 comprises a vertical partition wall 120 (shown in FIG. 8) within the cuboid-shaped box 102 separates a feed bin unit 122 and a reservoir unit 124. The feed bin unit 122 is configured to store feed pellets and the reservoir unit 124 is configured to store water. In some embodiments, the height of the vertical partition wall 120 is same as the height of each of the four vertical walls 104-110. In some embodiments, the volume of the feed bin unit 122 is same as the volume of the reservoir unit 124.

Further, the feeder device 100 comprises a first upper hatch 126 for the feed bin unit 122. Further, the feeder device 100 comprises a second upper hatch 128 for the reservoir unit 124.

Further, the feeder device 100 comprises a motor housing 130. The motor housing 130 comprises a motor (not shown) to power an auger (not shown) installed within the feed bin unit 122, wherein the motor housing 130 is attached to an outer wall of the feed bin unit 122. As shown in FIG. 4, the motor housing 130 is attached to the vertical wall 108 of the feed bin unit 122.

Further, the feeder device 100 comprises a feeder 132 attached to an outer wall of the feed bin unit 122, wherein the feeder 132 receives the feed pellets from the feed bin unit 122 through the auger. As shown in FIG. 4, the feeder 132 is attached to the vertical wall 108 of the feed bin unit 122.

Further, the feeder device 100 comprises a trough 134 attached to an outer wall of the reservoir unit 124, wherein the trough 134 receives water from the reservoir unit 124. As shown in FIG. 6, the trough 134 is attached to the vertical wall 104 of the reservoir unit 124. In some embodiments, the reservoir unit 124 may dispense water to the trough 134 through a float valve system.

In some embodiments, the plurality of anchor legs 112-118 are secured to the ground by a plurality of stakes 136-142 (for e.g. stake 136, stake 138, stake 140, stake 142) respectively.

In some embodiments, the first upper hatch 126 is hinged to the vertical partition wall 120 using at least one hinge (not shown). In alternate embodiments, the first upper hatch 126 is hinged to at least one vertical wall in the four vertical walls 104-110. Further, a top surface of the first upper hatch 126 may include a first handle 144 (as shown in FIG. 7). Further, the first upper hatch 126 may be configured to rotate around the at least one hinge and provide an opening to the feed bin unit 122 when the first handle 144 is pulled away from the feeder device 100, as shown in FIG. 8.

In some embodiments, the second upper hatch 128 is hinged to the vertical partition wall 120 using at least one hinge (not shown). In alternate embodiments, the second upper hatch 128 is hinged to at least one vertical wall in the four vertical walls 104-110. Further, a top surface of the second upper hatch 128 may include a second handle 146. Further, the second upper hatch 128 is configured to rotate around the at least one hinge and provide an opening to the reservoir unit 124 when the second handle 146 is pulled away from the feeder device 100, as shown in FIG. 8.

In some embodiments, the first upper hatch 126 includes one or more latches 148-154 (including latch 148, latch 150, latch 152, and latch 154) for securing the first upper hatch 126 to at least one of the four vertical walls 104-110 in a closed position, as shown in FIG. 7.

In some embodiments, the second upper hatch 128 includes one or more latches 152-154 for securing the second upper hatch 128 to at least one of the four vertical walls 104-110 in a closed position, as shown in FIG. 7.

In some embodiments, the motor housing 130 comprises a motor housing door 156 for maintenance access.

In some embodiments, the feeder device 100 may include a solar panel (not shown) to provide power to the motor in the motor housing 130.

In some embodiments, the feeder device 100 may include a battery to provide power to the motor in the motor housing 130.

In some embodiments, at least one wall of the feed bin unit 122 may include a feed bin window 158 for monitoring the amount of feed pellets in the feed bin unit 122.

In some embodiments, at least one wall of the reservoir unit 124 includes a reservoir window 160 for monitoring the level of water in the reservoir unit 124.

In some embodiments, the feed bin unit 122 may include a feed bin floor 162 over the base member, wherein the feed bin floor 162 slopes down towards the feeder 132.

In some embodiments, the reservoir unit 124 includes a reservoir floor 164 over the base member, wherein the reservoir floor 164 slopes down towards the trough 134.

According to some embodiments, the feeder device 100 includes the internal auger-fed feed bin unit 122 and the internal water reservoir unit 124, both with large storage capacities and hinged, latched hatches 126-128 for refilling purposes. The feeder device 100 may be used to attract deer and similar game animals for hunting or other purposes.

Further, the feed bin unit 122 occupies the rear half of the feeder device 100, and provides the feed bin window 158 for monitoring the content level, and the feed bin floor 162 which slopes to the rear. The feed bin unit 122 further provides the motor housing 130 at the lower edge of the vertical wall 108. The motor housing 130 provides an internal battery-powered electric motor powering the auger, and the motor housing door 156 for maintenance access. The motor may optionally be powered by a solar panel or other alternate power supply. The feed bin unit 122 further provides the feeder 132 fed by the auger, which dispenses feed pellets from the feed bin unit 122.

The reservoir unit 124 occupies the front half of the feeder device 100, and provides the reservoir window 160 for monitoring the content level, and the reservoir floor 164, which slopes to the vertical wall 104. The reservoir unit 124 further provides the trough 134 at the lower edge of the vertical wall 104, which dispenses drinking water through a float valve system.

The hatches 126-128 are hinged, and include handles (such as the first handle 144, and the second handle 146) for opening the hatches 126-128, and the one or more latches 148-154 for securing the hatches 126-128 in the closed position. In the open position, the hatches 126-128 may be used to refill the feed bin unit 122 and the reservoir unit 124. At the lower four corners of the feeder device 100, the plurality of the anchor legs 112-118 extend outward at a 135 angle from the side surface. Each anchor leg in the plurality of the anchor legs 112-118 may be secured to the ground by a stake in the plurality of stakes 136-142.

To use the first exemplary embodiment, the user may secure the feeder device 100 to the ground, using the plurality of the anchor legs 112-118 and the plurality of stakes 136-142. The user may then open the hatches 126-128, fill the feed bin unit 122 with feed pellets, and fill the reservoir unit 124 with water. Finally, the user may then close the hatches 126-128 and secure them with the one or more latches 148-154.

Further, the feeder device 100, the feed bin unit 122, the feed bin floor 162, the reservoir unit 124, the reservoir floor 164, and the hatches 126-128 may be manufactured from rigid, durable materials which are lightweight and provide substantial structural strength, such as plywood, fiberglass, and high-impact plastic. The feed bin window 158 and the reservoir window 160 may be manufactured from rigid, durable materials which are shatterproof and transparent, such as transparent plastic or malacrylate.

Further, the motor housing 130, the motor housing door 156, the feeder 132, the trough 134, the plurality of the anchor legs 112-118, the plurality of stakes 136-142, and the auger may be manufactured from rigid, durable materials with substantial structural strength, such as steel and aluminum alloy. The motor may be manufactured from rigid, durable materials such as steel, aluminum alloy, brass, copper alloy, ceramics, and plastic. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

Although the present disclosure has been explained in relation to its preferred embodiment, it is to be understood that many other possible modifications and variations can be made without departing from the spirit and scope of the disclosure.

What is claimed is:

1. A feeder device for attracting game comprising:
a cuboid-shaped box comprising four vertical walls joined at the edges of a base member;
a plurality of anchor legs supporting the base member;
a vertical partition wall within the cuboid-shaped box separating a feed bin unit and a reservoir unit, wherein the feed bin unit is configured to store feed pellets and the reservoir unit is configured to store water;
a first upper hatch for the feed bin unit;
a second upper hatch for the reservoir unit;
a motor housing comprising a motor to power an auger installed within the feed bin unit, wherein the motor housing is attached to an outer wall of the feed bin unit;
a feeder attached to an outer wall of the feed bin unit, wherein the feeder receives the feed pellets from the feed bin unit through the auger; and
a trough attached to an outer wall of the reservoir unit, wherein the trough receives water from the reservoir unit.

2. The feeder device of claim 1, wherein the plurality of anchor legs is secured to the ground by a plurality of stakes.

3. The feeder device of claim 1, wherein the height of the vertical partition wall is same as the height of each of the four vertical walls.

4. The feeder device of claim 1, wherein the volume of the feed bin unit is same as the volume of the reservoir unit.

5. The feeder device of claim 1, wherein the first upper hatch is hinged to at least one of the four vertical walls and the vertical partition wall using at least one hinge.

6. The feeder device of claim 5, wherein a top surface of the first upper hatch includes a first handle, wherein the first upper hatch is configured to rotate around the at least one hinge and provide an opening to the feed bin unit when the first handle is pulled away from the feeder device.

7. The feeder device of claim 1, wherein the second upper hatch is hinged to at least one of the four vertical walls and the vertical partition wall using at least one hinge.

8. The feeder device of claim 7, wherein a top surface of the second upper hatch includes a second handle, wherein the second upper hatch is configured to rotate around the at least one hinge and provide an opening to the reservoir unit, when the second handle is pulled away from the feeder device.

9. The feeder device of claim 1, wherein the first upper hatch includes at least one latch for securing the first upper hatch to at least one of the four vertical walls in a closed position.

10. The feeder device of claim 1, wherein the second upper hatch includes at least one latch for securing the second upper hatch to at least one of the four vertical walls in a closed position.

11. The feeder device of claim 1, wherein the motor housing comprises a motor housing door.

12. The feeder device of claim 1 further comprising a solar panel to provide power to the motor in the motor housing.

13. The feeder device of claim 1 further comprising a battery to provide power to the motor in the motor housing.

14. The feeder device of claim 1, wherein at least one wall of the feed bin unit includes a feed bin window for monitoring the amount of feed pellets in the feed bin unit.

15. The feeder device of claim 1, wherein at least one wall of the reservoir unit includes a reservoir window for monitoring the level of water in the reservoir unit.

16. The feeder device of claim 1 wherein the feed bin unit includes a feed bin floor over the base member, wherein the feed bin floor slopes down towards the feeder.

17. The feeder device of claim 1 wherein the reservoir unit includes a reservoir floor over the base member, wherein the reservoir floor slopes down towards the trough.

18. The feeder device of claim 1 wherein the reservoir unit dispenses water to the trough through a float valve system.
